(19) United States
(12) Patent Application Publication
(10) Pub. No.: US 2005/0265059 A1
(43) Pub. Date: Dec. 1, 2005

(54) Multi-use power conversion modules

(76) Inventors: John G. Tracy, Raleigh, NC (US); Miguel E. Chavez, Raleigh, NC (US)

Correspondence Address: MYERS BIGEL SIBLEY & SAJOVEC, PO BOX 37428, RALEIGH, NC, 27627, US

(21) Appl. No.: 10/855,850

(22) Filed: May 27, 2004

(51) Int. Cl. H02M 7/5387

(52) U.S. Cl. 363/132

(57) ABSTRACT

A power conversion module includes a frame, first external connection terminals supported by the frame, and at least four half-bridge circuits supported by the frame and electrically coupled between selected pairs of the first external connection terminals. The module further includes respective second external connection terminals supported by the frame and electrically coupled to respective center nodes of respective ones of the at least four half-bridge circuits. The module may also include at least four inductors supported by the frame, respective ones of the at least four inductors coupling respective ones of the center nodes of the at least four half-bridge circuits to respective ones of the second external connection terminals. The module may further include at least one storage capacitor supported by the frame and electrically coupled between a pair of the first external connection terminals. The module may be used, for example, to provide rectifier and inverter functions in an uninterruptible power supply (UPS).

### BACKGROUND OF THE INVENTION

The present invention relates to electronic devices, and more particularly, to power conversion modules.

A power conversion device, such as an uninterruptible power supply (UPS), may include multiple power conversion circuits. For example, an online UPS may include a rectifier that is used to rectify an input AC voltage to generate a DC voltage and an inverter that generates an AC voltage from this DC voltage. The UPS may also include additional power conversion circuits, such as battery charger and/or converter circuits.

Such power conversion circuits often use common components. For example, the rectifier and inverter circuits of an online UPS may use substantially similar insulated gate bipolar transistor (IGBT) half-bridge circuits. Packaged multi-transistor devices have been developed for such applications. For example, “six pack” devices are offered that include three IGBT half-bridges mounted on a common heat sink and encased in a molded housing. Passive devices, such as inductors or capacitors, may be coupled to pins of such a device to form a rectifier, inverter, or other power conversion circuit.

### SUMMARY OF THE INVENTION

In some embodiments of the invention, a power conversion module includes a frame. The module also includes first external connection terminals supported by the frame, and at least four half-bridge circuits supported by the frame and electrically coupled between selected pairs of the first external connection terminals. The module further includes respective second external connection terminals supported by the frame and electrically coupled to respective center nodes of respective ones of the at least four half-bridge circuits. The module may also include at least four inductors supported by the frame, respective ones of the at least four inductors coupling respective ones of the center nodes of the at least four half-bridge circuits to respective ones of the second external connection terminals. The module may further include at least one storage capacitor supported by the frame and electrically coupled between a pair of the first external connection terminals. The at least four half-bridge circuits may include respective pairs of insulated gate bipolar transistors (IGBTs), and the module may further include respective third external connection terminals electrically coupled to gate terminals of the respective IGBTs. Such a module may be configurable to serve in a plurality of different power conversion circuit configurations, for example, a rectifier configuration or an inverter configuration.

According to further embodiments of the invention, a power conversion module includes a frame and first external connection terminals supported by the frame. The module further includes at least four half-bridge circuits supported by the frame and coupled between selected pairs of the first external connection terminals. The module also includes respective second external connection terminals supported by the frame, at least four inductors supported by the frame and coupling respective center nodes of respective ones of the at least four half-bridge circuits to respective ones of the second external connection terminals, and at least one storage capacitor supported by the frame and electrically coupled between a pair of the first external connection terminals.

In some embodiments of the invention, the frame may include a sheet metal chassis configured to provide a channel, a heat sink mounted in the channel, and a printed circuit board mounted on a surface of the chassis opposite the channel. The at least four half-bridge circuits may be mounted on the printed circuit board and may include switching devices, e.g., IGBTs, that contact the heat sink. The at least four inductors may be mounted within the channel and electrically coupled to the printed circuit board. The at least one storage capacitor may be mounted on the printed circuit board and may extend into the channel through an opening in the chassis.

According to further embodiments of the invention, a UPS includes at least two power conversion modules. Each of the modules includes a frame, first external connection terminals supported by the frame, at least four half-bridge circuits supported by the frame and electrically coupled between selected pairs of the first external connection terminals, and respective second external connection terminals supported by the frame and electrically coupled to respective center nodes of respective ones of the at least four half bridge circuits. Each of the first and second modules may also include at least four inductors supported by the frame and coupling respective ones of the center nodes of the at least four half-bridge circuits to respective ones of the second external connection terminals. Each of the first and second modules may further include at least one storage capacitor supported by the frame and electrically coupled between a pair of the first external connection terminals. The first and second modules may be configured, for example, to provide respective rectifier and inverter functions.

In some embodiments of the invention, a first set of the first external connection terminals of the first module is part of a first DC bus and a second set of the first external connection terminals of the first module is part of a second DC bus such the at least four half-bridge circuits of the first module are coupled between the first and second DC busses. The first inductors of the first module are configured to be coupled to respective phases of an AC bus, and at least one second inductor of the first module is configured to be coupled to a DC power source.

In further embodiments of the invention, a first set of the first external connection terminals of the first module is part of a first DC bus and a second set of the first external connection terminals of the first module are part of a second DC bus such that a first set of the at least four half-bridge circuits of the first module is coupled between the first and second DC busses. At least one of the first external connection terminals of the first module is configured to be coupled to a DC power source such that at least one of the at least four half-bridge circuits of the first modules is configured to be coupled between the second DC bus and the DC power source. The first inductors of the first module are configured to be coupled to respective phases of an AC bus, and at least one second inductor of the first module is configured to be coupled to the first DC bus.

In some embodiments of the invention, a first set of the first external connection terminals of the second module are part of a first DC bus and a second set of the first external connection terminals of the second module is part of a second DC bus such the at least four half-bridge circuits of the first module are coupled between the first and second DC busses. First inductors of the second module are configured to be coupled to respective phases of an AC bus, and at least one second inductor of the second module is configured to be coupled to a neutral of the AC bus.

### BRIEF DESCRIPTION OF THE DRAWINGS

FIGS. 1-4 illustrate power conversion modules according various embodiments of the invention.

FIGS. 5 and 6 illustrate power module configurations in UPSs according various embodiments of the invention.

FIGS. 7-10 illustrate power conversion modules for use in a multi-phase UPS according to still further embodiments of the invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present. As used herein the term “and/or” includes any and all combinations of one or more of the associated listed items. Like numbers refer to like elements throughout.

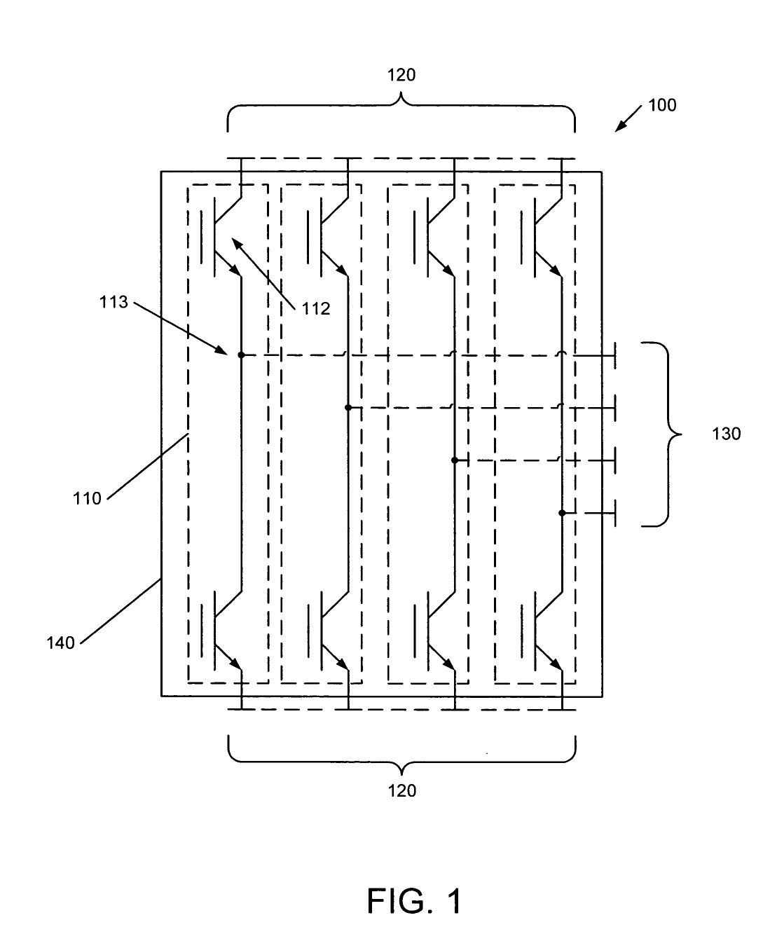

FIG. 1 illustrates a power conversion module 100 according to some embodiments of the invention. The module 100 includes four half-bridge circuits 110, here shown as including IGBTs 112. The half bridge circuits 110 are coupled between pairs of external connection terminals 120. As indicated by the dashed lines, the external connection terminals 120 may include individual pairs of terminals for individual ones of the half-bridge circuits 110 and/or some of the half-bridge circuits 110 may be coupled in common to pairs of the external connection terminals 120. Respective center nodes 113 of the half-bridge circuits 110 are coupled to respective external connection terminals 130. As indicated by the dashed lines, the connections between the center nodes 113 and the external connection terminals 130 may be direct and/or via intervening components.

The half-bridge circuits 110 and the connection terminals 120, 130 are supported by a frame 140. The frame 140 may include any of a number of different mechanical structures, including, but not limited to molded cases (with or without integral heat sinks) and composite structures including, for example, combinations of structural members and printed circuit board(s). Although the module 100 is shown as using IGBTs, it will be appreciated that the half-bridge circuits 110 may use other devices, such as field-effect transistors (FETs) or silicon controlled rectifiers (SCRs). The external connection terminals 120, 130 may include any of a number of different types of connection terminals, including, but not limited to, solderable terminals, compression-type terminals (e.g., socket, pin, blade), and screw terminals.

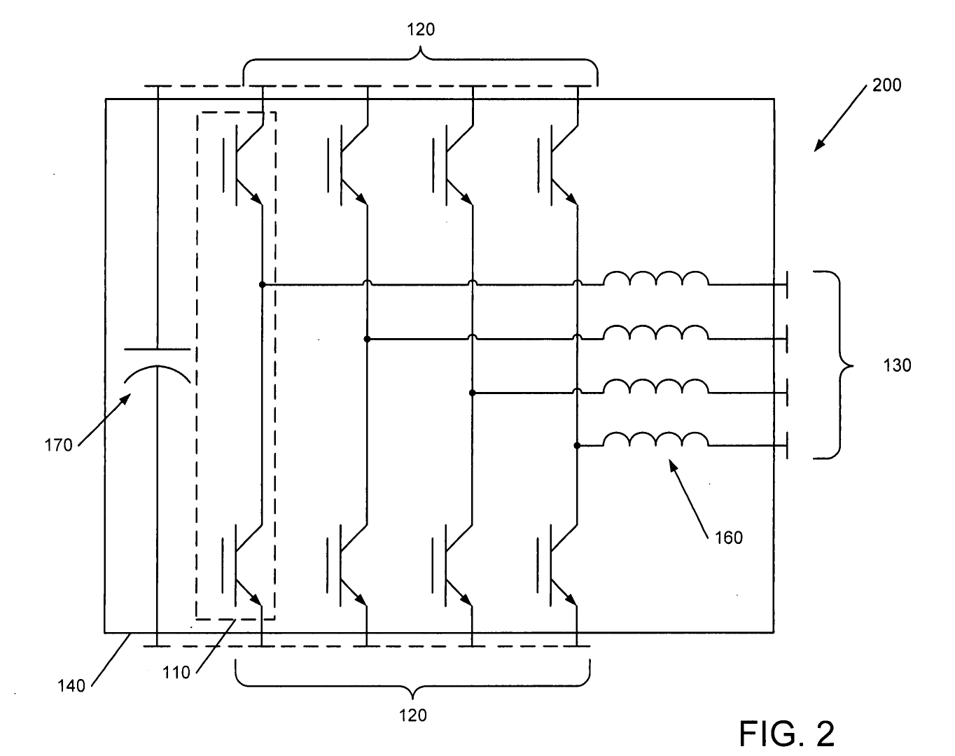

As shown in FIG. 2, in further embodiments, a power conversion module 200 may include half-bridge circuits 110, a frame 140, and connection terminals 120, 130 as described above with reference to FIG. 1, along with respective inductors 160 that couple respective ones of the center nodes 113 of the half-bridge circuits 110 to respective ones of the external connection terminals 130, and at least one storage capacitor 170 coupled between a pair of the external connection terminals 120.

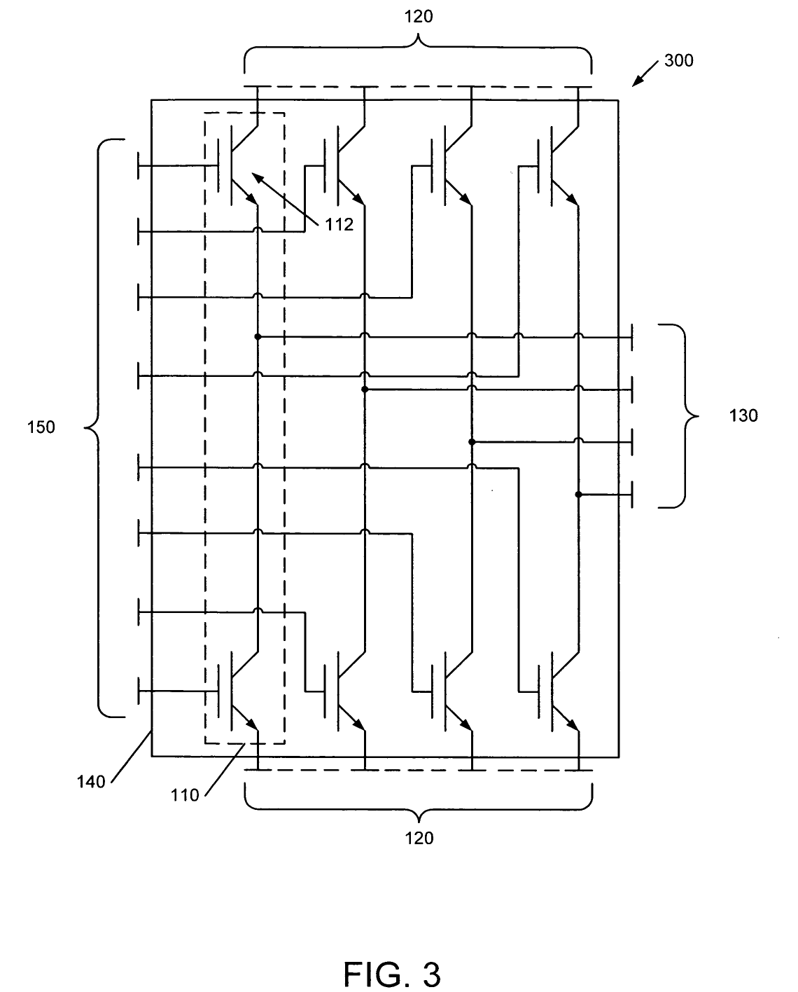

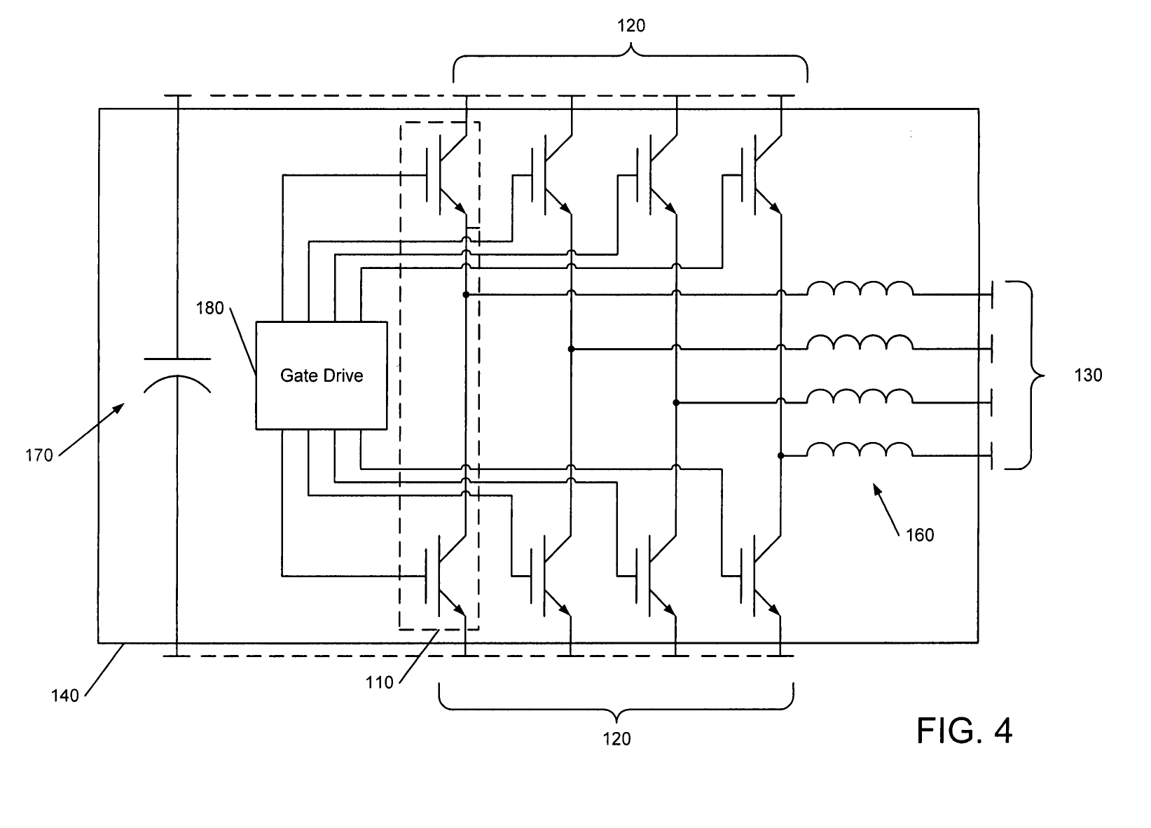

In embodiments of the invention illustrated in FIG. 3, a power conversion module 300 may include half-bridge circuits 110, a frame 140 and external connection terminals 120, 130 as described above with reference to FIG. 1, and may also include external connection terminals 150 coupled to respective gate terminals of the IGBTs 112. It will be appreciated that the external connection terminals 140 may be coupled to gate drive circuitry that is external to the module 300. Alternatively, as shown in FIG. 4, a power conversion module 400 may include components as shown in FIG. 2, along with integral gate drive circuitry 180.

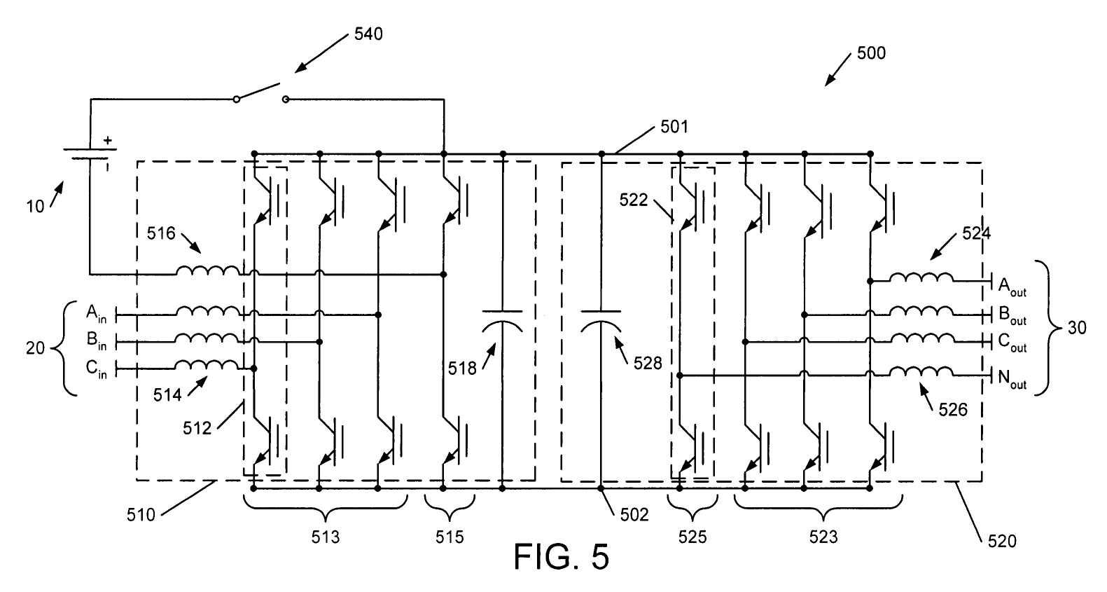

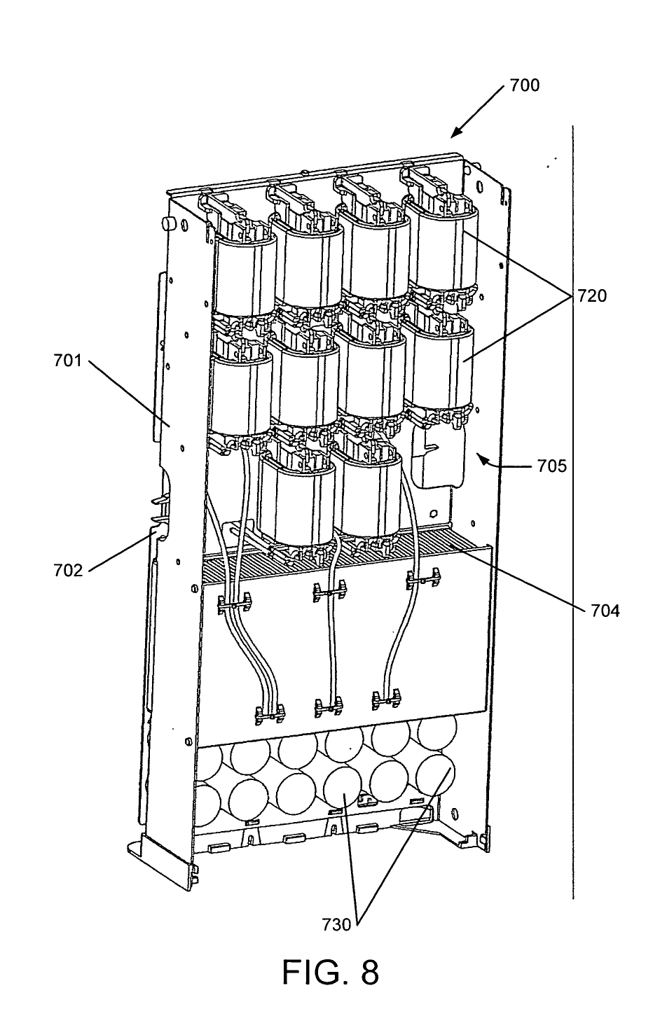

Some embodiments of the invention arise from a novel realization that a potentially more useful power conversion module for multi-phase applications may include more than the three half-bridges provided in conventional modules, such as IGBT “six packs.” For example, in many applications, it may be desired to provide neutral modulation in addition to phase modulation in an inverter, as shown, for example, in U.S. patent application Ser. No. 10/763,962 (Attorney Docket No. 9060-204), filed Jan. 23, 2004 and incorporated herein by reference in its entirety. In other applications, it may be desirable to provide battery conversion and/or DC bus balancing capability in combination with three-phase power conversion. Potential advantages of power conversion modules such as those shown in FIGS. 1-4 in exemplary UPS applications are described below in reference to FIGS. 5-10.

FIG. 5 illustrates an exemplary use of power conversion modules in a UPS 500 according to some embodiments of the invention. The UPS 500 includes a first module 510 that includes three half-bridge circuits 513 that are configured for use in a synchronous boost rectifier that transfers power between an AC bus 20, e.g., a utility input bus, and DC busses 501, 502. The first module 510 also includes three inductors 514 that are configured to couple respective ones of the three half-bridge circuits 513 to respective phases Aᵢₙ, Bᵢₙ, Cᵢₙ of the AC bus 20. A fourth half-bridge circuit 515 is configured to be coupled to one terminal of a DC source, here shown as a battery 10, via a fourth inductor 516. A switch 540 couples another terminal of the battery 10 to the DC bus 501. The fourth half-bridge circuit 515 may serve as a battery converter/charger. The first module 510 further includes a storage capacitor 518 coupled between the DC busses 501, 502.

The UPS 500 further includes a second module 520 that includes three half-bridge circuits 523 that are configured as an inverter that couples the DC busses 501, 502 to an AC bus 30. The second module 520 includes three inductors 524 that couple respective ones of the three half-bridge circuits 523 to respective phases Aₒᵤₜ, Bₒᵤₜ, Cₒᵤₜ of the AC bus 30, and a fourth inductor 526 that couples a fourth half-bridge circuit 525 to a neutral Nₒᵤₜ of the AC bus 30. The fourth half-bridge circuit 525 may be used as a neutral modulator as described, for example, in the aforementioned U.S. patent application Ser. No. 10/763,962. The second module 520 further includes a storage capacitor 528 coupled between the DC busses 501, 502. For purposes of clarity of illustration, control circuitry for driving the half-bridge circuits 513, 515, 523, 525 is not shown in FIG. 5, but it will be appreciated that a number of different types of control circuits may be used with the invention, and that this control circuitry may be separate from the modules 510, 520 and/or integrated into the modules 510, 520.

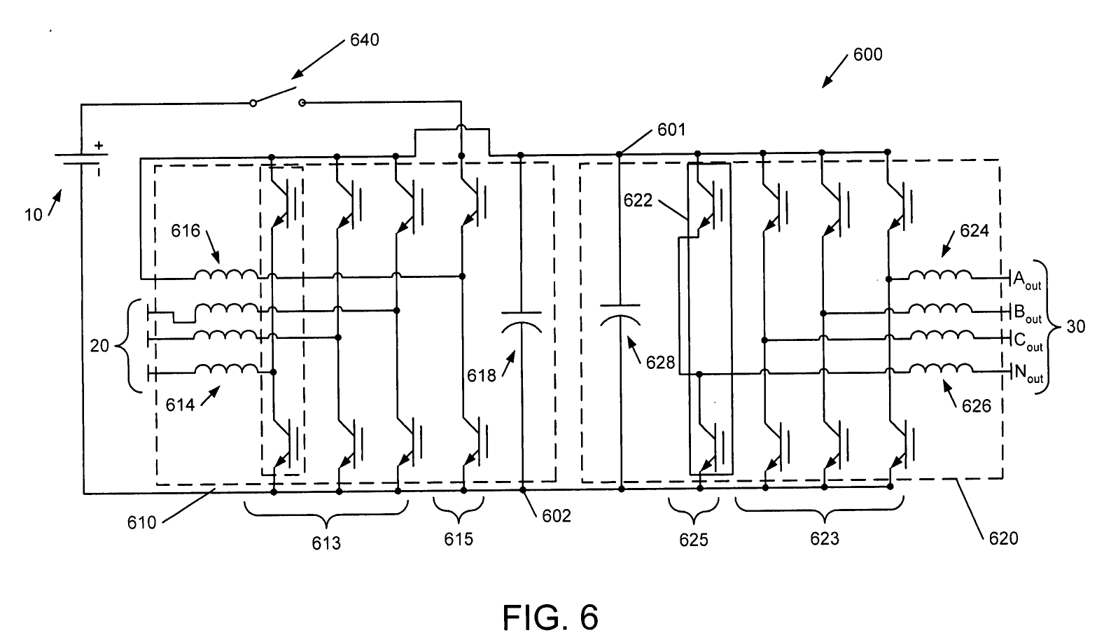

FIG. 6 illustrates a UPS 600 according to further embodiments of the invention. The UPS 600 includes a first module 610 that includes three half-bridge circuits 613 that are configured for use in a synchronous boost rectifier that couples an AC bus 20, e.g., a utility input bus, to DC busses 601, 602. The first module 610 also includes three inductors 614 that are configured to coupled respective center nodes of the circuits 613 to respective phases Aᵢₙ, Bᵢₙ, Cᵢₙ of the AC bus 20. A fourth half-bridge circuit 615 is configured to be coupled to the first DC bus 601 via a fourth inductor 616. A switch 640 couples and decouples a terminal of a battery 10 to and from one of the IGBTs of the fourth half-bridge circuit 615. A second terminal of the battery 10 is coupled to the second DC bus 602. The fourth half-bridge circuit 615 may serve as a battery converter/charger. The first module 610 further includes a storage capacitor 618 coupled between the DC busses 601, 602.

The UPS 600 further includes a second module 620 that includes three half-bridge circuits 623 that are configured as an inverter that couples the DC busses 601, 602 to an AC bus 30. The second module 620 includes three inductors 624 that couple respective ones of the three half-bridge circuits 623 to respective phases Aₒᵤₜ, Bₒᵤₜ, Cₒᵤₜ of the AC bus 30, and a fourth inductor 626 that couples a fourth half-bridge circuit 625 to a neutral Nₒᵤₜ of the AC bus 30. The fourth half-bridge circuit 625 may be used as a neutral modulator as described above. The second module 620 further includes a storage capacitor 628 coupled between the DC busses 601, 602. For purposes of clarity of illustration, control circuitry for driving the half-bridge circuits 613, 615, 623, 625 is not shown in FIG. 6, but it will be appreciated that a number of different types of control circuits may be used with the invention, and that this control circuitry may be separate from the modules 610, 620 and/or integrated into the modules 610, 620.

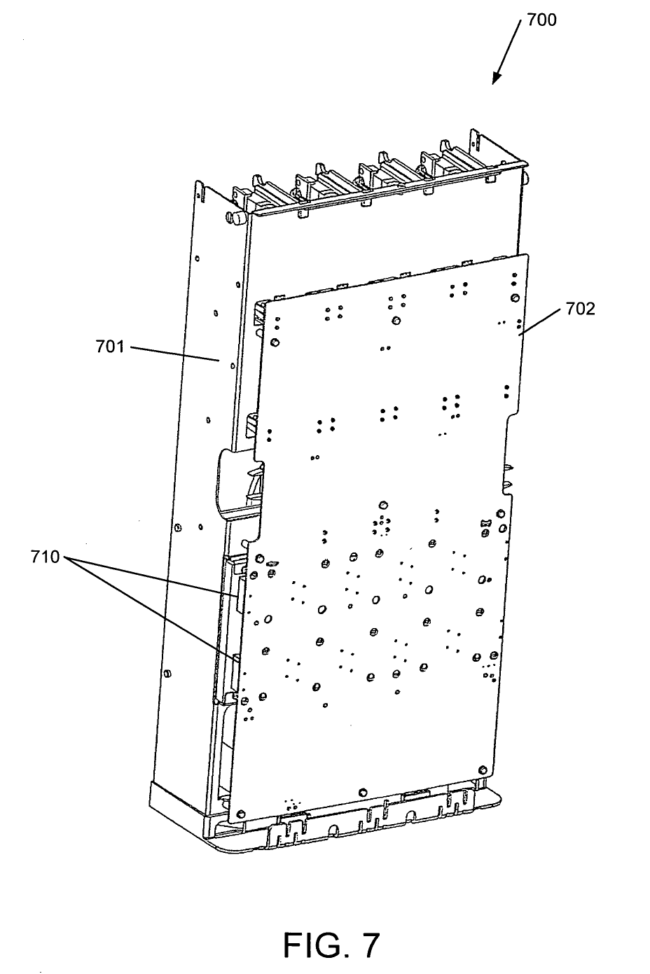

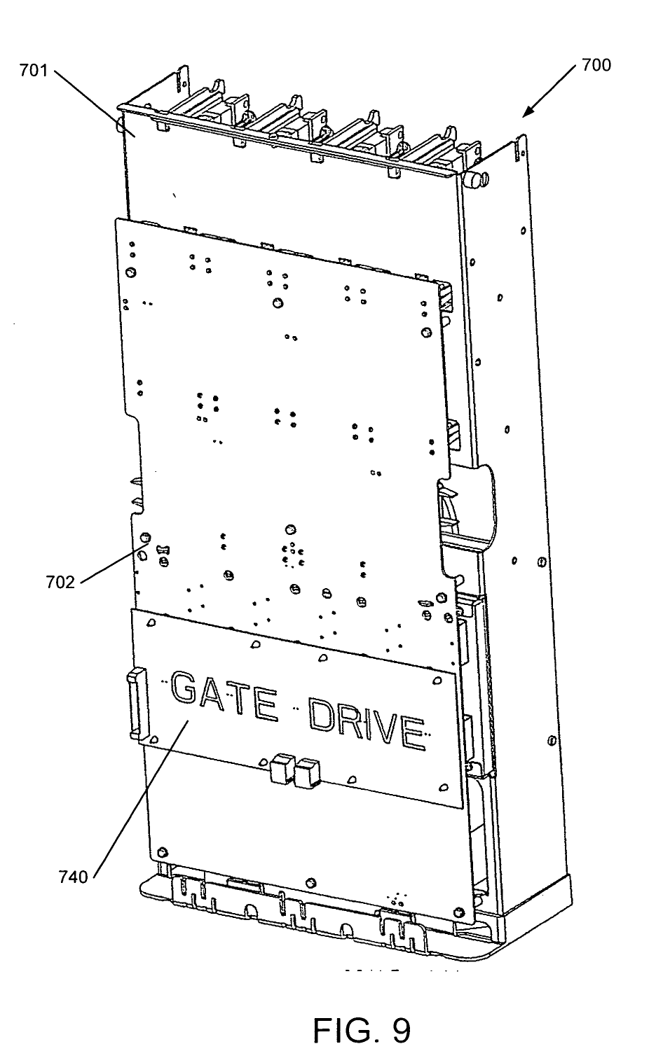

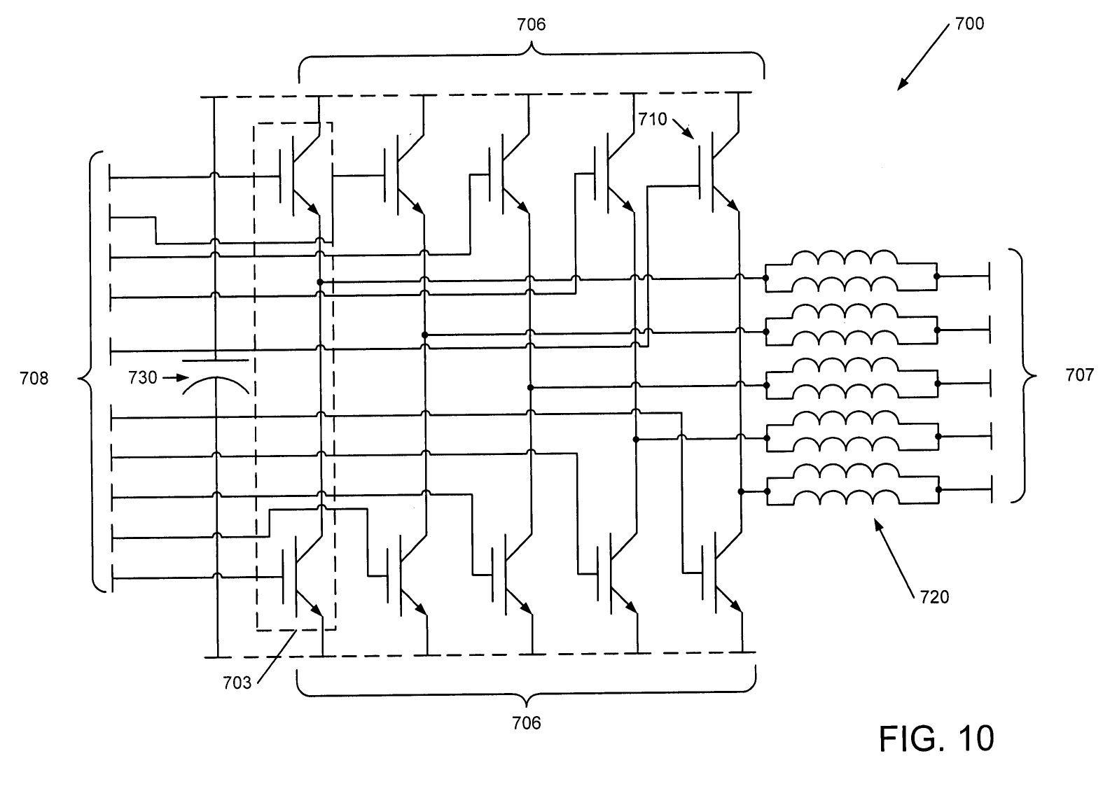

FIGS. 7-10 illustrate a power conversion module 700 according to further embodiments of the invention. The module 700 includes a frame comprising a sheet metal (e.g., aluminum) chassis 701 having a channel 705 defined therein, and a printed circuit board 702 mounted on the chassis 701, opposite the channel 705. Five half-bridge circuits 703 include IGBTs 710 mounted on the circuit board 702. A heat sink 704 is mounted in the channel 705 of the chassis 701, and contacts the IGBTs 710. Ten inductors 720 connected as shown in FIG. 10 are mounted in the channel 705 and electrically coupled to the circuit board 702 through one or more openings in the chassis 701. A plurality of storage capacitors 730 (shown as an aggregate capacitance in FIG. 10) is also positioned in the channel 705 and electrically coupled to the printed circuit board 702. As shown in FIG. 9, a gate drive circuit module 740 may be attached to the printed circuit board 702. External connection terminals 706, 707, 708 for the module 700 may be provided on the circuit board 702.

The module 700 illustrated in FIGS. 7-10 may be configured to provide various power conversion functions, including rectifier, inverter and battery converter functions. For example, in an online UPS configuration, two such modules may be used to provide respective rectifier and inverter functions. Additional rectifier or inverter capacity may be obtained by paralleling such modules.

In the drawings and specification, there have been disclosed exemplary embodiments of the invention. Although specific terms are employed, they are used in a generic and descriptive sense only and not for purposes of limitation, the scope of the invention being defined by the following claims.

1. A power conversion module comprising:
a frame;
first external connection terminals supported by the frame;
at least four half-bridge circuits supported by the frame and electrically coupled between selected pairs of the first external connection terminals; and
respective second external connection terminals supported by the frame and electrically coupled to respective center nodes of respective ones of the at least four half-bridge circuits.

2. A module according to claim 1, further comprising at least four inductors supported by the frame, respective ones of the at least four inductors coupling respective ones of the center nodes of the at least four half-bridge circuits to respective ones of the second external connection terminals.

3. A module according to claim 1, further comprising at least one storage capacitor supported by the frame and electrically coupled between a pair of the first external connection terminals.

4. A module according to claim 1, wherein the at least four half-bridge circuits comprise respective pairs of insulated gate bipolar transistors (IGBTs), and wherein the module further comprises respective third external connection terminals electrically coupled to gate terminals of the respective IGBTs.

5. A module according to claim 1, configurable to serve in a plurality of different power conversion circuit configurations.

6. A module according to claim 5, configurable to provide a rectifier configuration and an inverter configuration.

7. A power conversion module comprising:
a frame;
first external connection terminals supported by the frame;
at least four half-bridge circuits supported by the frame and coupled between selected pairs of the first external connection terminals;
respective second external connection terminals supported by the frame;
at least four inductors supported by the frame and coupling respective center nodes of respective ones of the at least four half-bridge circuits to respective ones of the second external connection terminals; and
at least one storage capacitor supported by the frame and electrically coupled between a pair of the first external connection terminals.

8. A module according to claim 7, wherein the at least four half-bridge circuits comprise respective pairs of insulated gate bipolar transistors (IGBTs), and wherein the module further comprises respective third external connection terminals electrically coupled to gate terminals of the respective IGBTs.

9. A module according to claim 7:
wherein the frame comprises:
a sheet metal chassis configured to provide a channel;
a heat sink mounted in the channel; and
a printed circuit board mounted on a surface of the chassis opposite the channel;
wherein the at least four half-bridge circuits are mounted on the printed circuit board and include transistors that contact the heat sink through an opening in the chassis;
wherein the at least four inductors are mounted within the channel and electrically coupled to the printed circuit board; and
wherein the at least one storage capacitor comprises at least one capacitor mounted on the printed circuit board and having a case that extends into the channel through an opening in the chassis.

10. A module according to claim 9:
wherein the at least four half-bridge circuits comprises five half-bridge circuits mounted on the printed circuit board and, each including switching devices that contact the heat sink; and
wherein the at least four inductors comprises ten inductors, respective pairs of which are coupled to respective center nodes of the five half-bridge circuits.

11. A module according to claim 9, further comprising a gate drive module mechanically supported by the frame and electrically coupled to the printed circuit board.

12. A module according to claim 9, configurable to provide a plurality of different power conversion circuit configurations.

13. A module according to claim 9, configurable to provide a rectifier configuration and an inverter configuration.

14. A UPS comprising:
first and second power conversion modules, each of which comprises:
a frame;
first external connection terminals supported by the frame;
at least four half-bridge circuits supported by the frame and electrically coupled between selected pairs of the first external connection terminals; and
respective second external connection terminals supported by the frame and electrically coupled to respective center nodes of respective ones of the at least four half bridge circuits.

15. A UPS according to claim 14, wherein each of the first and second modules further comprises at least four inductors supported by the frame and coupling respective ones of the center nodes of the at least four half-bridge circuits to respective ones of the second external connection terminals.

16. A UPS according to claim 15, wherein each of the first and second modules further comprises at least one storage capacitor supported by the frame and electrically coupled between a pair of the first external connection terminals.

17. A UPS according to claim 16:
wherein a first set of the first external connection terminals of the first module is part of a first DC bus and a second set of the first external connection terminals of the first module is part of a second DC bus such the at least four half-bridge circuits of the first module are coupled between the first and second DC busses;
wherein first inductors of the first module are configured to be coupled to respective phases of an AC bus; and
wherein at least one second inductor of the first module is configured to be coupled to a DC power source.

18. A UPS according to claim 17, wherein the first module is configured as a synchronous rectifier and a battery converter.

19. A UPS according to claim 16:
wherein a first set of the first external connection terminals of the first module are part of a first DC bus and a second set of the first external connection terminals of the first module are part of a second DC bus such that a first set of the at least four half-bridge circuits of the first module is coupled between the first and second DC busses;
wherein at least one of the first external connection terminals of the first module is configured to be coupled to a DC power source such that at least one of the at least four half-bridge circuits of the first modules is configured to be coupled between the second DC bus and the DC power source;
wherein first inductors of the first module are configured to be coupled to respective phases of an AC bus; and
wherein at least one second inductor of the first module is configured to be coupled to the first DC bus.

20. A UPS according to claim 19, wherein the first module is configured as a synchronous rectifier and a battery converter.

21. A UPS according to claim 16:
wherein a first set of the first external connection terminals of the second module is part of a first DC bus and a second set of the first external connection terminals of the second module is part of a second DC bus such the at least four half-bridge circuits of the second module are coupled between the first and second DC busses; and
wherein first inductors of the second module are configured to be coupled to respective phases of an AC bus; and
wherein at least one second inductor of the second module is configured to be coupled to a neutral of the AC bus.

22. A UPS according to claim 21, wherein the second module is configured as an inverter and a neutral modulator.

23. A UPS according to claim 14, wherein each of the first and second modules further comprises at least one storage capacitor supported by the frame and electrically coupled between a pair of the first external connection terminals.

24. A UPS according to claim 14, wherein the at least four half-bridge circuits comprise respective pairs of insulated gate bipolar transistors (IGBTs), and wherein the module further comprises respective third external connection terminals electrically coupled to gate terminals of the respective IGBTs.

25. A UPS according to claim 14, wherein the first and second modules are configured to provide respective different power conversion operations.

26. A UPS according to claim 25, wherein the first and second modules are configured to provide respective rectifier and inverter functions.
